(19) United States
(12) Patent Application Publication
(10) Pub. No.: US 2024/0106758 A1
(43) Pub. Date: Mar. 28, 2024

(54) Simple Hierarchical Quality of Service (HQoS) Marking

(71) Applicant: Telefonaktiebolaget LM Ericsson (publ), Stockholm (SE)

(72) Inventors: Szilveszter Nádas, Santa Clara, CA (US); Sándor Laki, Budapest (HU); Gergo Gombos, Budapest (HU); Ferenc Fejes, Budapest (HU)

(21) Appl. No.: 18/266,874

(22) PCT Filed: Jan. 5, 2022
(86) PCT No.: PCT/IB2022/050068

§ 371 Date: Jun. 13, 2023

Related U.S. Application Data
(60) Provisional application No. 63/137,345, filed on Jan. 14, 2021.

(51) Int. Cl. H04L 47/24; H04L 47/31

(52) U.S. Cl. CPC H04L 47/24; H04L 47/31

(57) ABSTRACT

This disclosure provides a technique for hierarchical packet marking for Core-Stateless Active Queue Management (CSAQM). In particular, a network node measures the bitrate of each of a plurality of subflows that comprise a traffic aggregate (TA). The plurality of subflows in the TA belong to a single entity, and each subflow has a normalized weight value. The node modifies a random rate determination for a throughput-value function (TVF) associated with the TA based on the bitrates and weight of each subflow in the TA. Then, based on the modified rate, the node calculates a packet value (PV) with which to mark a packet in a given subflow, and marks the packet with the PV. Marking packets according to the techniques disclosed herein achieves a desired weighted resource sharing, and ensures that the random rates are uniformly distributed for the entire TA.

### RELATED APPLICATIONS

The present application claims benefit of U.S. Provisional Application 63/137,345, which was filed Jan. 14, 2021, the disclosure of which is incorporated herein by reference in its entirety.

### TECHNICAL FIELD

This application relates generally to packet marking, and more particularly to techniques that control hierarchical resource sharing using packet marking.

### BACKGROUND

Conventionally, networks are shared among different entities. By way of example only, different network operators will generally share the same telecom equipment. Thus, the cost of building and maintaining the network is spread across many operators rather than just a single operator. Further, network sharing allows the operators to concentrate more on the services they offer to their customers, as well as the quality of those services.

Related to sharing a network is the concept of network slicing. Network slicing, which was recently introduced, is a network architecture that enables using the same network for different services. More particularly, network slicing allows for multiplexing virtualized and independent logical networks on the same physical network infrastructure. Each slice is an isolated end-to-end network specially configured to fulfil the requirements required by a particular application. Thus, the various entities that use these networks (e.g., user equipment (UE), other network devices, etc.) share the resources.

Typically, each of the entities sharing the network communicate multiple traffic flows. As defined herein, all traffic flows belonging to a single entity is a Traffic Aggregate (TA). Generally, resource sharing is defined among several TAs that belong to the same hierarchical level (e.g., among subscribers). However, it is also defined within the higher hierarchy level TAs (e.g., slices) with the higher-level TAs obtaining more of the assignable resources. One very simple example of such weighted resource sharing follows.
Operator-1 vs. Operator-2=3:1
Slice 1 vs. slice 2 (of Operator 1)=1:1
Gold subscriber(s) vs. Silver subscriber(s) (of Slice 1)=2:1
Web flow(s) vs. Download flow(s) (for a Silver subscriber)=2:1
   Additionally, in a concept that is orthogonal to resource sharing, different TAs may have different preferred requirements surrounding delay and jitter.

The above notwithstanding, there are other factors that can, or will, begin to affect resource sharing. For example, current “bottlenecks” in a network occur at the so-called “last hop.” However, as networks evolve and the speed of the last hops increase (e.g., using 5G radio, fiber to the destination such as a user's home, etc.), routers might become the bottlenecks. Moreover, the traffic at these bottlenecks is heterogeneous when considering the type of congestion control being used, Round Trip Time (RTT) requirements, and the like. Additionally, the mix of traffic is continuously changing. However, even at routers where bottlenecks occur, a user's Quality of Experience (QoE) can be significantly improved if resource sharing is well controlled.

### SUMMARY

Embodiments of the present disclosure provide techniques for achieving hierarchical packet marking for Core-Stateless Active Queue Management (CSAQM). To accomplish this function, the present embodiments take advantage of the fact that the weights of all subflows belonging to a given TA, and the policy for the whole TA at a single point where the packet will be marked, are known.

Embodiments of the present disclosure provide a method of hierarchical packet marking. The method is implemented by a node in a communications network and comprises measuring a bitrate of each of a plurality of subflows in a traffic aggregate (TA). In this embodiment, the plurality of subflows in the TA belong to a single entity. Further, each subflow in the plurality of subflows has a normalized weight value.

The method further comprises determining a throughput-value function (TVF) for the TA. Then, for each subflow, an adjusted bitrate value is determined based on the measured bitrate and the normalized weight value for the subflow. A data packet in a given subflow of the TA can then be marked as a function of the TVF and the adjusted bitrate value for the subflow.

Embodiments of the present disclosure also provide a node in a communications network. In one embodiment, the node comprises communications interface circuitry and processing circuitry operatively coupled to the communications interface circuitry. The communications interface circuitry is configured to communicate with one or more other nodes in the network. The processing circuitry is configured to measure a bitrate of each of a plurality of subflows in a traffic aggregate (TA), wherein the plurality of subflows in the TA belong to a single entity with each subflow having a normalized weight value, determine a throughput-value function (TVF) for the TA, determine, for each subflow, an adjusted bitrate value based on the measured bitrate and the normalized weight value for the subflow, and mark a packet of a subflow as a function of the TVF and the adjusted bitrate value for the subflow.

Embodiments of the present disclosure also provide a non-transitory computer-readable medium. In one embodiment, a computer program is stored thereon. The computer program comprises instructions that, when executed by processing circuitry in a node configured to perform hierarchical packet marking, causes the node to measure a bitrate of each of a plurality of subflows in a traffic aggregate (TA), wherein the plurality of subflows in the TA belong to a single entity with each subflow having a normalized weight value, determine a throughput-value function (TVF) for the TA, determine, for each subflow, an adjusted bitrate value based on the measured bitrate and the normalized weight value for the subflow, and mark a packet of a subflow as a function of the TVF and the adjusted bitrate value for the subflow.

### BRIEF DESCRIPTION OF THE DRAWINGS

FIG. 1 is a functional block diagram illustrating a communications network configured according to one embodiment of the present disclosure.

FIG. 2 is a functional block diagram illustrating hierarchical Quality of Service (QoS) scheduling according to one embodiment of the present disclosure.

FIG. 3 is a graph illustrating an example throughput-value function (TVF).

FIG. 4 is a flow diagram illustrating a method implemented by a network node in a communications network according to one embodiment of the present disclosure.

FIG. 5 is a flow diagram illustrating a method for marking the data packets of a subflow according to one embodiment of the present disclosure.

FIG. 6 is a graph illustrating the regions of a TVF associated with a traffic aggregate (TA) according to one embodiment. Different subflows use the regions.

FIGS. 7A-7C are graphs illustrating the distribution of the random number after adjustment for two example subflows of a TA according to one embodiment of the present disclosure.

FIG. 8 is a functional block diagram illustrating some components of a network node configured to implement embodiments of the present disclosure.

FIG. 9 is a functional block diagram illustrating some modules of a computer program product executed by processing circuitry of the network node according to one embodiment of the present disclosure.

### DETAILED DESCRIPTION

Embodiments of the present disclosure provide techniques for achieving hierarchical packet marking for Core-Stateless Active Queue Management (CSAQM). To achieve such hierarchical packet marking, the present embodiments measure the bitrate of all subflows belonging to the same traffic aggregate (TA). Then, based on these measurements and the normalized weights of the subflows, the present embodiments determine throughput regions. When performing packet marking, the present embodiments determine, for each subflow, a random bitrate value between 0 and the measured bitrate of the subflow. Depending on the throughput region the random bitrate value falls into, the present embodiments adjust the random bitrate value. The adjustment may be performed, for example, based on a comparison between the random bitrate value and a subflow-specific bitrate limit. If the random bitrate value is less than the subflow-specific bitrate limit, the random bitrate value is adjusted based on the weight value of a subflow. If the random bitrate value is not less than the subflow-specific bitrate limit, the random bitrate value is adjusted by adding a constant (e.g., the bitrate of another subflow) to the random bitrate value. This adjusted bitrate (also referred to as the “equivalent rate”) is then used in the TAs throughput-value function (TVF) to determine the packet value that is to be used to mark a packet of the subflow.

Embodiments of the present disclosure provide advantages and benefits that conventional packet marking solutions do not or cannot provide. For example, if resource sharing is not directly controlled, the result will be an approximate flow fairness. This is due, at least partially, to Transport Control Protocol (TCP) congestion control behavior. Such conventional behaviors are also very limiting. In particular, new congestion controls and heterogenous round trip times (RTTs) typically result in unfairness among flows. Additionally, a user with several subflows can dominate resource usage over a single bottleneck. Static reservation also requires defining the bitrate share of each TA in advance. This typically results in a large amount of unused resources.

The present embodiments, in contrast, address such issues. In particular, embodiments of the present disclosure are simple to implement, but yet, still achieve hierarchical resource sharing. Additionally, the present embodiments require very few variables, and as such, is computationally simple. However, despite its simplicity, embodiments of the present disclosure still provide all the advantages of Hierarchical Quality of Service (HQoS). By way of example only, the present embodiments can ensure that a user's streaming-based gaming session (e.g., a first subflow) does not lose data packets, while the rest of the user's subflows are congestion controlled by packet loss. Additionally, the present embodiments can achieve this goal while avoiding starving those other subflows. Moreover, according to the present embodiments, the TA can be further included in hierarchical resource sharing using other methods and techniques that maintain the weighted sharing of the subflows.

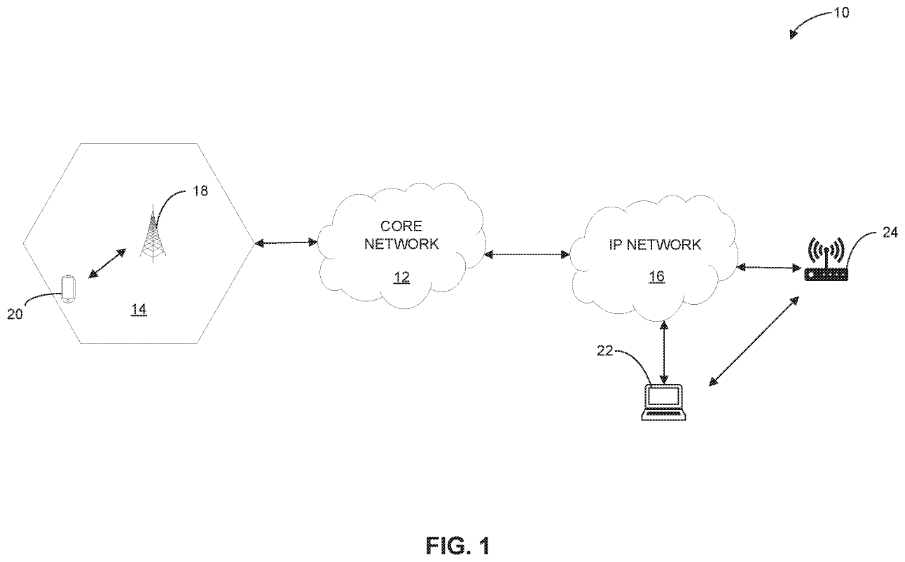

Turning now to the drawings, FIG. 1 is a functional block diagram illustrating a communications network 10 configured to function according to one embodiment of the present disclosure. As seen in FIG. 1, network 10 comprises a core network (CN) 12 communicatively connecting a Radio Access Network (RAN) 14 and an IP network 16 (e.g., a public data network such as the Internet and/or a private data network). The RAN 14, as is known in the art, comprises one or more base stations 18 that communicate with one or more User Equipments (UEs) 20 according to known techniques. The IP network 16 communicates with one or more devices, such as computer 22 via wireline (e.g., ETHERNET) and/or a wireless router 24. According to the present embodiments, a node disposed in network 10 (e.g., in CN 12 and/or IP network 16) implement hierarchical packet marking for Core-Stateless Active Queue Management (CSAQM).

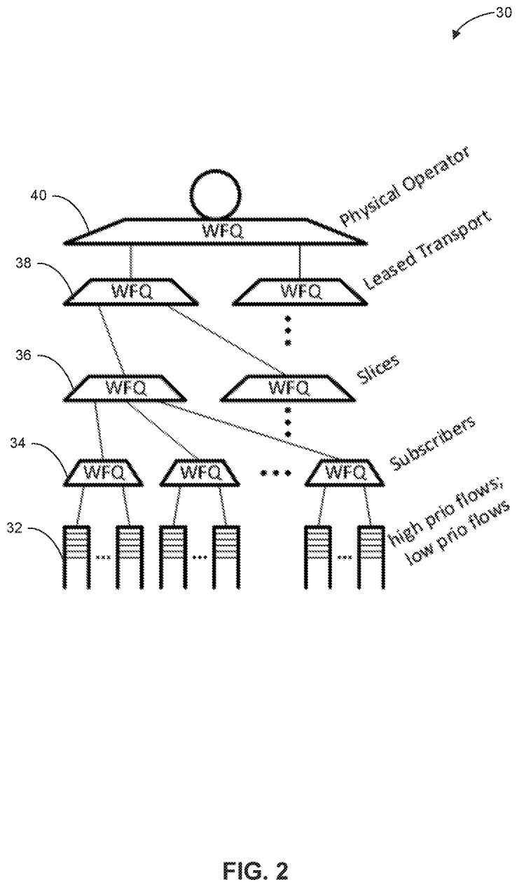

FIG. 2 is a functional block diagram illustrating a Weighted Fair Queuing (WFQ) system 30 for Hierarchical Quality of Service (HQoS) scheduling according to one embodiment of the present disclosure. As seen in FIG. 2, system 30 comprises subflows of data 32 (i.e., high-priority and/or low-priority subflows), and a plurality of WFQs 34, 36, 38, and 40 at different levels.

Hierarchical QoS by Scheduling is a complex system with hierarchical scheduler and a plurality of WFQs 34, 36, 38, and 40. However, it is able to implement a rich set of policies and realizes statistical multiplexing. As the number of TAs increase (both the hierarchical levels of TAs and the number of TAs per level), its computational complexity and memory demands increase. Thus, configuration of such systems is complex and it requires configuration at each bottleneck.

Core Stateless AQM can implement simple HQoS. In particular, it introduces a “re-marker” in a domain border and shows that no policy or flow knowledge is needed in the network. Rather, CSAQM needs only a very simple scheduler that uses a packet value marked on each packet of a flow. Other re-markers operate according to general requirements, however they can be further simplified for special case scenarios. One such special case, for example, is when the data packets of a flow and all of its subflows are marked at the same point. There are some conventional methods that simplify strict priority scheduling among subflows. However, none of the known methods provide a solution for weighted fairness among subflows.

To discuss the present embodiments, the weighted fairness solution according to the present disclosure is illustrated with respect to first and second subflows belonging to the same TA. However, those of ordinary skill in the art should readily appreciate that this is for illustrative purposes only. Embodiments of the present disclosure are equally as suitable for any number of subflows in a TA and any number of TAs.

The (normalized) weights of the first and second subflows are indicated herein as w₁ and w₂, respectively. The weights are normalized when the sum of all weights equal to 1. By way of example only, when w₁=0.25 and w₂=0.75, it indicates that the second subflow shall experience 3 times the bitrate of the first subflow.

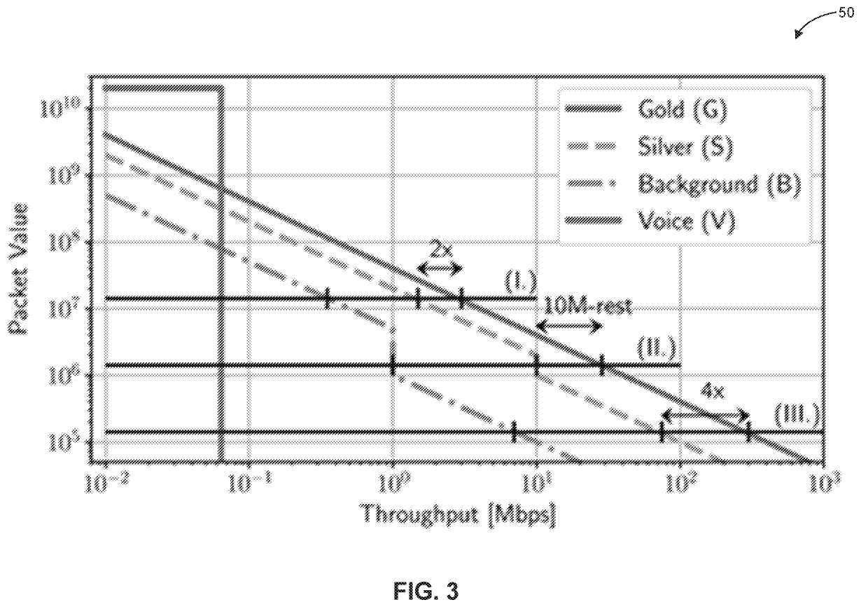

According to the present disclosure, a node in the network first measures the bitrates R₁, R₂, respectively, of each of subflow in each TA. The throughput-value function (TVF) of the entire TA determines the resource sharing policy of the aggregate. For example, FIG. 3 is a graph illustrating an example TVF 50. The throughput lies along the ‘x’ axis and the corresponding packet value used to mark a given packet lies along the ‘y’ axis. Thus, as seen in FIG. 3, the throughput (e.g., 10 Mbps) determines the packet value that belongs to a subflow-specific bitrate limit of 10 Mbps.

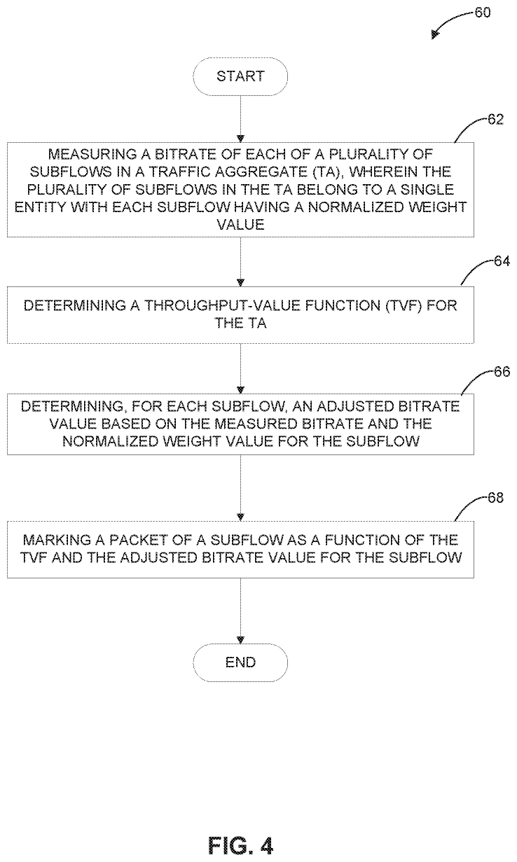

In more detail, FIG. 4 is a flow diagram illustrating a method 60 implemented by a network node in a communications network according to one embodiment of the present disclosure. As seen in FIG. 4, method 60 begins with the network node measuring a bitrate of each of a plurality of subflows in a TA (box 62). As stated above, the plurality of subflows in the TA belong to a single entity with each subflow having a normalized weight value. The node then determines a TVF for the TA based on the normalized weight value and the measured bitrate of each subflow in the TA (box 64). So determined, the node then determines, for each subflow, an adjusted bitrate value based on the measured bitrate and the normalized weight value for the subflow (box 66) and marks the packet as a function of the TVF and the adjusted bitrate value for the subflow (box 68).

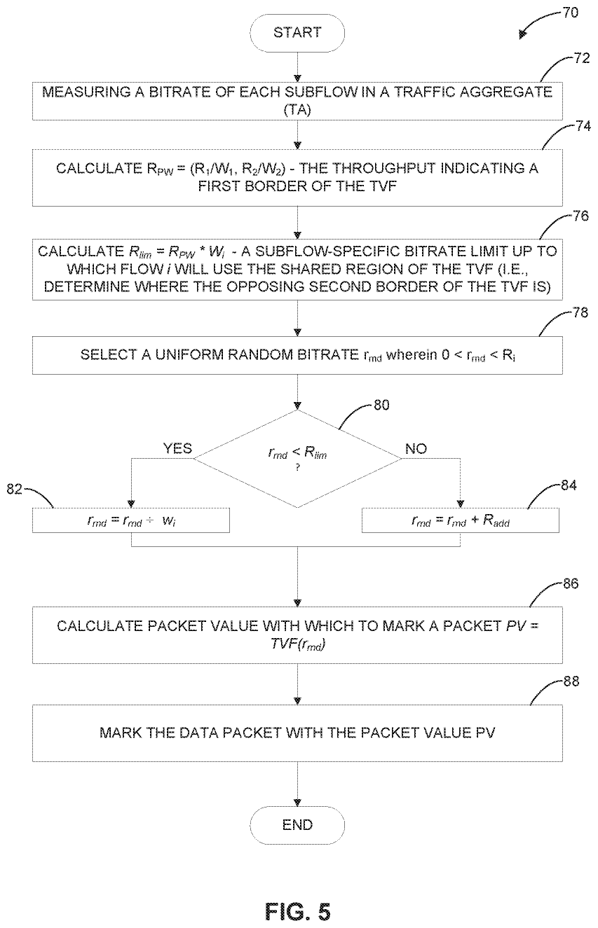

FIG. 5 is a flow diagram illustrating a method 70 for marking the data packets of a subflow according to one embodiment of the present disclosure. As with method 60 of FIG. 4, the node also implements method 70 of FIG. 5 in this embodiment.

In method 70, the implementing node first measures the bitrates of each subflow in a TA (box 72). The node then calculates (box 74) the throughput rate that indicates a first border of the TVF as:

R_{pw}=MIN(R₁/w₁,R₂/w₂)

wherein:
R₁ and R₂=the measured bitrates of the first and second subflows in TA, respectively; and
w₁ and w₂=the weight values of the first and second subflows in TA, respectively.

Next, the node calculates (box 76) the subflow-specific bitrate limit up to which the flow i will use the shared region of the TVF as:

Rₗᵢₘ=R_{pw}*wᵢ.

wherein:
Rₗᵢₘ is a subflow-specific bitrate limit up to which subflow i will use a shared region of the TVF. The value for Rₗᵢₘ can be different for each subflow, even if R₁, R₂, w₁, and/or w₂ do not change; and
wᵢ is the weight value for subflow i.
   That is, the node calculates the subflow-specific bitrate limit that indicates a second border of the TVF. Between these first and second borders, both identified by a respectively calculated bitrate, is the shared region of the TVF.

The node then determines (box 78) a random bitrate value r_{rnd} for a subflow as:

r_{rnd}=0≤r_{rnd}≤Rᵢ

wherein Rᵢ is the measured bitrate of the subflow.

The node then compares (box 80) the random bitrate value r_{rnd} to the subflow-specific bitrate limit Rₗᵢₘ and calculates an adjusted bitrate value accordingly. Particularly, if the random bitrate value r_{rnd} is less than the subflow-specific bitrate limit Rₗᵢₘ (box 82), the node adjusts the random bitrate value r_{rnd} using:

r_{rnd}=r_{rnd}÷wᵢ.

However, if the random bitrate value r_{rnd} is not less than the subflow-specific bitrate limit Rₗᵢₘ (box 84), the node determines a bitrate R_{add} for a different subflow in the TA and adjusts the random bitrate value r_{rnd} based on that value as:

r_{rnd}=r_{rnd}+R_{add}

The node then calculates (box 86) the packet value (PV) with which to mark a data packet in a subflow as:

PV=TVF(r_{rnd})

and marks the data packet with the PV (box 88).

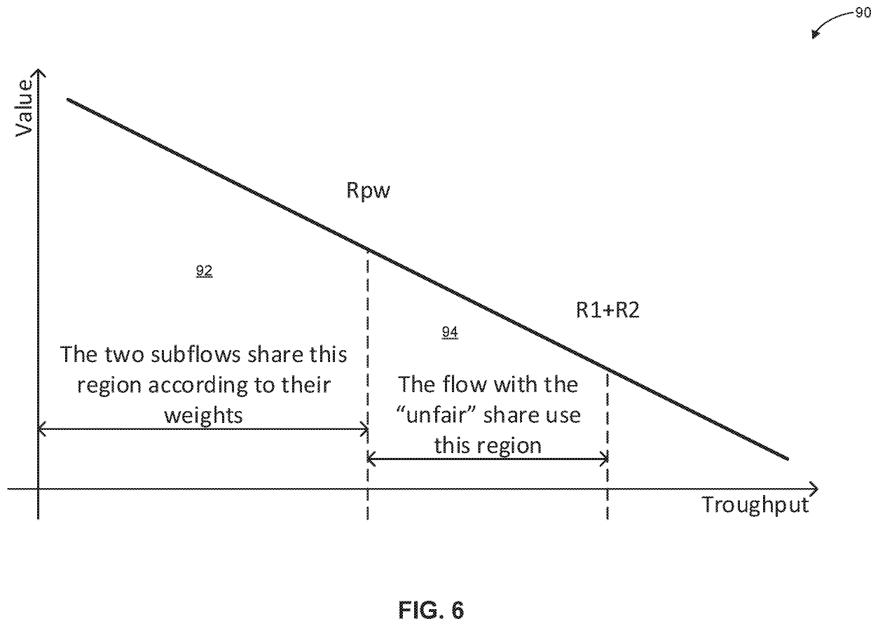

FIG. 6, which visualizes the behavior of the method seen in FIG. 5, is a graph 90 illustrating the regions of a TVF associated with a TA according to one embodiment. Different subflows use the regions.

In region 92, R_{pw} is used by both the first and second subflows according to their respective weights w₁, w₂. The region 94 between R_{pw} and R₁+R₂ is used only by one of the subflows, and more specifically, only by the subflow that has a higher share of the resources than intended based on its weight wᵢ. In a special optimal case this region is very small or 0, but there can be valid reasons for non-zero range. For example, such a situation may occur when one of the subflows is rate limited.

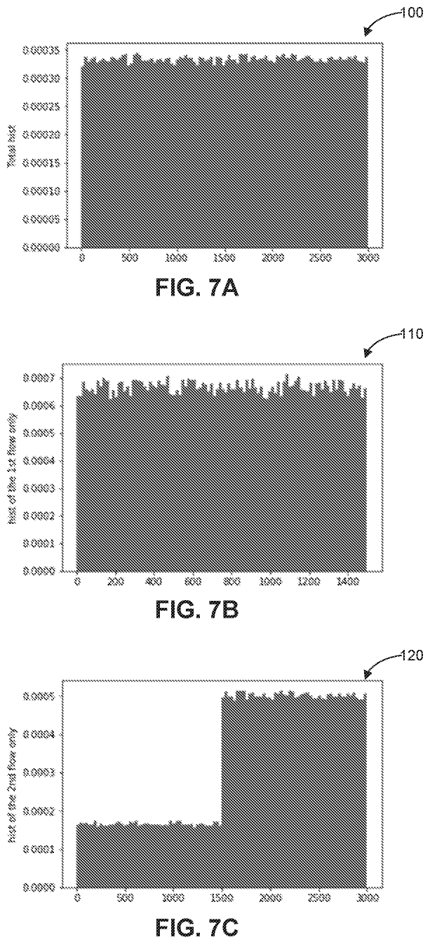

FIGS. 7A-7C are graphs 100, 110, and 120 illustrating the distribution of the random number after adjustment for the first and second example subflows of the TA according to one embodiment of the present disclosure. For example, consider the case the measured bitrate of the first subflow is R₁=1000 kbps, and the measured bitrate for the second subflow is R₂=2000 kbps. Further, consider the respective weights of the first and second subflows to be w₁=⅔ and w₂=⅓. Based on these values, the node performs the method of FIG. 5, and the statistics of the resulting r_{rnd} are plotted in FIGS. 7A-7C. As seen in these graphs, the first subflow only uses region 92—i.e., up to 1500 of the original TVF. The second subflow has a smaller probability of using region 92, but typically uses the remaining range in region 94 (i.e., 1500 . . . 3000). The combined distribution for the first and second flows is between 0 . . . 3000 and is generally uniform, as intended.

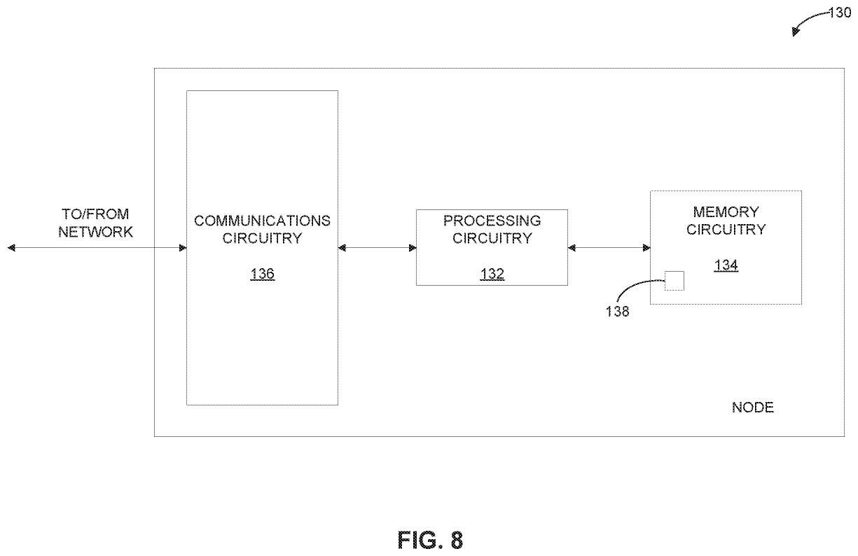

FIG. 8 is a functional block diagram illustrating some components of a network node 130 configured to implement embodiments of the present disclosure. As seen in FIG. 8, network node 130 comprises processing circuitry 132, memory circuitry 134, and communications circuitry 136. In addition, memory circuitry 134 stores a computer program 138 that, when executed by processing circuitry 132, configures network node 130 to implement the methods herein described.

In more detail, the processing circuitry 132 controls the overall operation of network node 130 and processes the data and information according to the present embodiments. Such processing includes, but is not limited to, measuring a bitrate of each of a plurality of subflows in a traffic aggregate (TA), wherein the plurality of subflows in the TA belong to a single entity with each subflow having a normalized weight value, determining a throughput-value function (TVF) for the TA, determining, for each subflow, an adjusted bitrate value based on the measured bitrate and the normalized weight value for the subflow, and marking a packet of a subflow as a function of the TVF and the adjusted bitrate value for the subflow. In this regard, the processing circuitry 132 may comprise one or more microprocessors, hardware, firmware, or a combination thereof.

The memory circuitry 134 comprises both volatile and non-volatile memory for storing computer program code and data needed by the processing circuitry 132 for operation. Memory circuitry 134 may comprise any tangible, non-transitory computer-readable storage medium for storing data including electronic, magnetic, optical, electromagnetic, or semiconductor data storage. As stated above, memory circuitry 134 stores a computer program 138 comprising executable instructions that configure the processing circuitry 132 to implement the methods herein described. A computer program 138 in this regard may comprise one or more code modules corresponding to the functions described above.

In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 138 for configuring the processing circuitry 132 as herein described may be stored in a removable memory, such as a portable compact disc, portable digital video disc, or other removable media. The computer program 138 may also be embodied in a carrier such as an electronic signal, optical signal, radio signal, or computer readable storage medium.

The communications circuitry 136 communicatively connects network node 130 to one or more other nodes via communications network 10, as is known in the art. In some embodiments, for example, communications circuitry 136 communicatively connects network node 130 to one or more other nodes in network 10. As such, communications circuitry 136 may comprise, for example, an ETHERNET card or other circuitry configured to communicate wirelessly with one or more other nodes via network 10.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

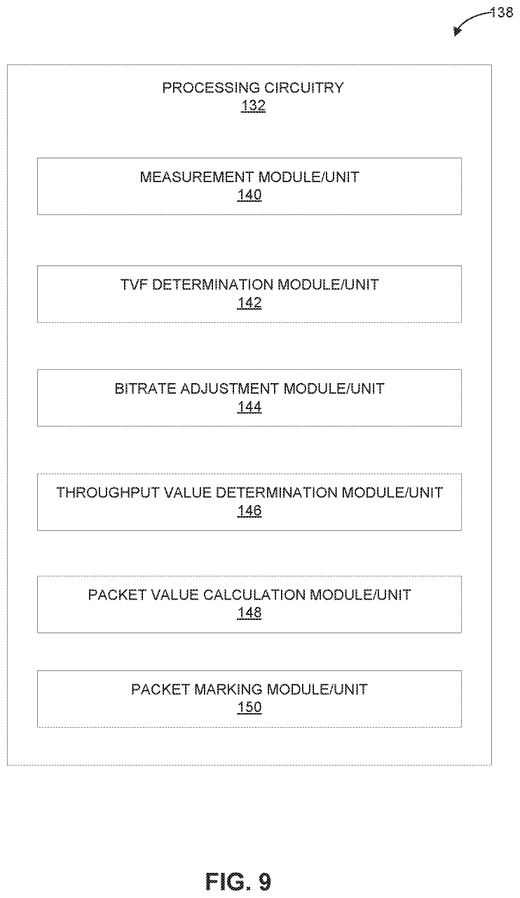

FIG. 9 is a functional block diagram illustrating some modules of computer program 138 executed by processing circuitry 132 of the network node according to one embodiment of the present disclosure. As seen in FIG. 9, computer program 138 executed by processing circuitry 132 comprises a measurement module/unit 140, a TVF determination module/unit 142, a bitrate adjustment module/unit 144, a throughput value determination module/unit 146, a packet value calculation module/unit 148, and a packet marking module/unit 150.

When computer program 138 is executed by processing circuitry 132, the measurement module/unit 140 configures network node 130 to measure a bitrate of each of a plurality of subflows in a traffic aggregate (TA), as described above. As previously stated, the plurality of subflows in the TA belong to a single entity and each subflow has a normalized weight value. The TVF determination module/unit 142 configures network node 130 to determine a throughput-value function (TVF) for the TA, as previously described. The bitrate adjustment module/unit 144 configures network node 130 to determine for each subflow, an adjusted bitrate value based on the measured bitrate and the normalized weight value for the subflow, as previously described. The throughput value determination module/unit 146 configures network node 130 to determine the throughput values for the TVF, as previously described. The packet value calculation module/unit 148 configures network node 130 to calculate the packet values with which to mark the packets of a subflow, as previously described. The packet marking module/unit 150 configures network node 130 to mark the data packets of a subflow with the calculated packet value, as previously described.

Embodiments further include a carrier containing such a computer program 138. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended embodiments are intended to be embraced therein.

1-15. (canceled)

16. A method of hierarchical packet marking, the method implemented by a node in a communications network and comprising:
measuring a bitrate of each of a plurality of subflows in a traffic aggregate (TA), wherein the plurality of subflows in the TA belong to a single entity with each subflow having a normalized weight value;
determining a throughput-value function (TVF) for the TA;
determining, for each subflow, an adjusted bitrate value based on a measured bitrate for the subflow and the normalized weight value for the subflow; and
marking a packet of a subflow as a function of the TVF and the adjusted bitrate value for the subflow.

17. The method of claim 16, wherein determining a throughput-value function (TVF) for the TA comprises determining first and second throughput values that define respective first and second borders of the TVF.

18. The method of claim 17, wherein the first throughput value R_{pw} is calculated as:
R_{pw}=MIN(R₁/w₁,R₂/w₂)
wherein:
R₁ and R₂=the measured bitrates of the first and second subflows in TA, respectively; and
w₁ and w₂=the weight values of the first and second subflows in TA, respectively.

19. The method of claim 18 wherein the second throughput value Rₗᵢₘ is calculated as:
Rₗᵢₘ=R_{pw}*wᵢ
wherein:
Rₗᵢₘ is a is a subflow-specific bitrate limit up to which subflow i will use a shared region of the TVF; and
wᵢ is the weight value for subflow i.

20. The method of claim 16 wherein determining, for each subflow, an adjusted bitrate value comprises determining a random bitrate value for a subflow as:
r_{rnd}=0≤r_{rnd}≤Rᵢ
wherein Rᵢ is the measured bitrate of the subflow.

21. The method of claim 20 wherein determining, for each subflow, an adjusted bitrate value further comprises comparing the random bitrate value to a subflow-specific bitrate limit Rₗᵢₘ.

22. The method of claim 21 wherein if the random bitrate value is less than the subflow-specific bitrate limit, the method further comprises calculating the adjusted bitrate as:
r_{rnd}=r_{rnd}÷wᵢ.

23. The method of claim 21 wherein if the random bitrate value is not less than the is a subflow-specific bitrate limit Rₗᵢₘ, the method further comprises:
determining a bitrate R_{add} for a different subflow in the TA; and
calculating the adjusted bitrate as r_{rnd}=r_{rnd}+R_{add}.

24. The method of claim 16 further comprising calculating a packet value with which to mark the packet in the subflow as PV=TVF(r_{rnd}).

25. The method of claim 16 wherein marking a packet of a subflow as a function of the TVF and the adjusted bitrate value for the subflow comprises marking the packet with the packet value PV.

26. A node in a communications network, the node comprising:
processing circuitry; and
memory comprising instructions executable by the processing circuitry whereby the node is configured to:
measure a bitrate of each of a plurality of subflows in a traffic aggregate (TA), wherein the plurality of subflows in the TA belong to a single entity with each subflow having a normalized weight value;
determine a throughput-value function (TVF) for the TA;
determine, for each subflow, an adjusted bitrate value based on the measured bitrate and the normalized weight value for the subflow; and
mark a packet of a subflow as a function of the TVF and the adjusted bitrate value for the subflow.

27. The node of claim 26, wherein to determine the throughput-value function (TVF) for the TA, the instructions are such that the node is further configured to determine first and second throughput values that define respective first and second borders of the TVF.

28. The node of claim 27,
wherein the first throughput value R_{pw} is calculated as:
R_{pw}=MIN(R₁/w₁,R₂/w₂),
and wherein the second throughput value Rₗᵢₘ is calculated as:
Rₗᵢₘ=R_{pw}*wᵢ
wherein:
R₁ and R₂=the measured bitrates of the first and second subflows in TA, respectively;
w₁ and w₂=the weight values of the first and second subflows in TA, respectively; and
Rₗᵢₘ is a is a subflow-specific bitrate limit up to which subflow i will use a shared region of the TVF; and
wᵢ is the weight value for subflow i.

29. The node of claim 26 wherein to determine, for each subflow, an adjusted bitrate value, the instructions are such that the node is further configured to determine a random bitrate value for a subflow as:
r_{rnd}=0≤r_{rnd}≤Rᵢ
wherein Rᵢ is the measured bitrate of the subflow.

30. The node of claim 29 wherein to determine, for each subflow, an adjusted bitrate value, the instructions are such that the node is further configured to compare the random bitrate value to a subflow-specific bitrate limit Rₗᵢₘ.

31. The node of claim 30 wherein if the random bitrate value is less than the subflow-specific bitrate limit Rₗᵢₘ, the instructions are such that the node is further configured to calculate the adjusted bitrate as:
r_{rnd}=r_{rnd}÷wᵢ.

32. The node of claim 30 wherein if the random bitrate value is not less than the subflow-specific bitrate limit Rₗᵢₘ, the instructions are such that the node is further configured to:
determine a bitrate R_{add} for a different subflow in the TA; and
calculate the adjusted bitrate as r_{rnd}=r_{rnd}+R_{add}.

33. The node of claim 26, wherein the instructions are such that the node is further configured to calculate the adjusted bitrate as a packet value with which to mark the packet in the subflow as PV=TVF(r_{rnd}).

34. The node of claim 26 wherein to mark a packet of a subflow as a function of the TVF and the adjusted bitrate value for the subflow, the instructions are such that the node is further configured to mark the adjusted bitrate as the packet with the packet value PV.

35. A non-transitory computer-readable medium comprising a computer program stored thereon, the computer program comprising instructions that, when executed by processing circuitry of a node configured to perform hierarchical packet marking causes the node to:
measure a bitrate of each of a plurality of subflows in a traffic aggregate (TA), wherein the plurality of subflows in the TA belong to a single entity with each subflow having a normalized weight value;
determine a throughput-value function (TVF) for the TA;
determine, for each subflow, an adjusted bitrate value based on the measured bitrate and the normalized weight value for the subflow; and
mark a packet of a subflow as a function of the TVF and the adjusted bitrate value for the subflow.
